(19) United States
(12) Patent Application Publication
(10) Pub. No.: US 2009/0178641 A1
(43) Pub. Date: Jul. 16, 2009

(54) ENGINE

(76) Inventor: Lyle DAWSON, Chatham (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/336,718

(22) Filed: Dec. 17, 2008

Related U.S. Application Data
(60) Provisional application No. 61/014,148, filed on Dec. 17, 2007.

(51) Int. Cl. F02B 75/32

(52) U.S. Cl. 123/197.4; 123/193.6; 123/193.2

(57) ABSTRACT

An engine comprising a cylinder including a piston and piston rod combination; a rotational hub; a crankshaft, connected at one end to the piston and piston rod combination and at a second end to the rotational hub; a gear train including an orbital gear, a stationary gear and a plurality of intermediary gears; and a crankshaft gear, located on an end of the crankshaft, the crankshaft gear meshing with the gear train so that movement of the crankshaft can drive a drive shaft.

### CROSS REFERENCE TO RELATED APPLICATIONS

This application claims the benefit of priority of U.S. Provisional Patent Application No. 61/014,148 filed Dec. 17, 2007, which is incorporated herein by reference in its entirety.

### FIELD OF THE INVENTION

The invention relates in general to engines and more specifically to a two (2) cycle turbo charged diesel engine.

### BACKGROUND OF THE INVENTION

In the past, it is known to have a two cylinder internal combustion engine with each cylinder having a piston that causes a crankshaft to rotate around a stationary gear to rotate a disc, which in turn rotates the drive shaft. The crankshaft makes two revolutions for each revolution of the disc and the drive shaft. Each cylinder has a separate drive shaft and a separate crankshaft and are actually two separate engines driven in sequence by chains. The engine has two compression peaks on its compression stroke and it is believed that the cylinder would have to fire on the first compression peak or on the second compression, making the engine impractical.

Another prior art engine has a piston slidably located within a cylinder, the cylinder being located within an engine block. A piston rod has one end pivotally connected to a piston and another end rotatably connected to a cam of a crankshaft. The crankshaft has an orbital gear thereon and the engine block has a stationary gear mounted thereon. The stationary gear is substantially larger than the orbital gear. The orbital gear and the stationary gear are mounted relative to one another to intermesh as the piston reciprocates with the orbital gear and the crankshaft rotating completely around the stationary gear during each stroke of the piston, the crankshaft being connected to drive a drive shaft. The stationary gear to orbital gear ratio is preferably 2:1.

It is, therefore, desirable to provide an engine which overcomes the disadvantages of the prior art.

### SUMMARY OF THE INVENTION

It is an object of the present invention to obviate or mitigate at least one disadvantage of previous engines.

In one aspect of the invention, there is provided a two cycle turbo charged diesel engine. Unlike other prior art engines, there is no requirement for a 2:1 ratio between a stationary gear and an orbital gear nor is a 1:1 rotation of the gears required. As the orbital gear is not connected to the crankshaft, it can therefore rotate at different speeds than the crankshaft which allows the gears to mesh with different teeth on subsequent rotations which reduces the amount of wear on various gears within a gear train. Also, the engine is able to produce a high level of torque.

In one aspect there is provided an engine comprising a piston and piston rod combination; a rotational hub; a crankshaft, connected at one end to the piston and piston rod combination and at a second end to the rotational hub; a gear train including an orbital gear, a stationary gear and a plurality of intermediary gears; and a crankshaft gear, located on an end of the crankshaft, the crankshaft gear meshing with the gear train so that movement of the crankshaft can drive a drive shaft.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1a is a schematic top view of an engine;

FIG. 1b is a schematic end view of the engine of FIG. 1a;

FIG. 1c is a schematic diagram of another embodiment of an engine;

FIG. 2a is a perspective view of a gear train for use in an engine;

FIG. 2b is a side view of another embodiment of a gear train;

FIG. 3 is a schematic view of the rotating hub and power shaft;

FIG. 4 is a graph outlining the effect of different ratios of crankshaft throw to crankshaft offset on piston stroke;

FIG. 5 is a table outlining torque improvements;

FIG. 6 is a partial schematic view of a piston and cylinder combination; and

FIGS. 7a to 7c are views of multiple cylinder embodiments.

### DETAILED DESCRIPTION

Generally, the present invention provides an engine for a vehicle. More specifically, the invention is directed at a two (2) cycle turbo charged diesel engine. When the word stroke is referred to in this specification, it shall be interpreted as referring to one downward movement and one upward movement of the piston. In other words, a downward stroke and an upward stroke of the piston, taken together, represent one stroke i.e. a 360 degree rotation of the power shaft.

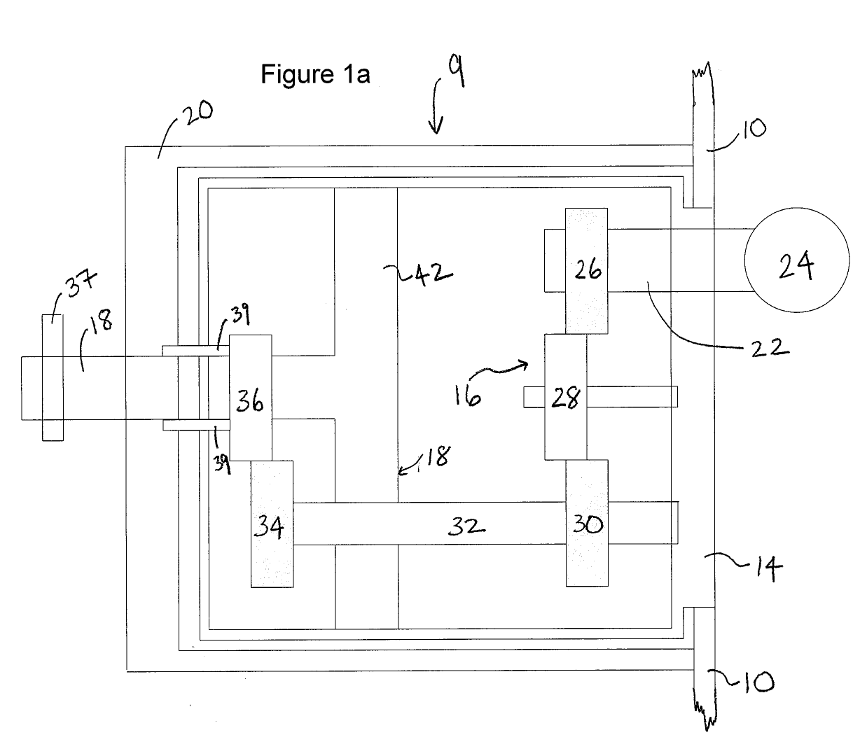

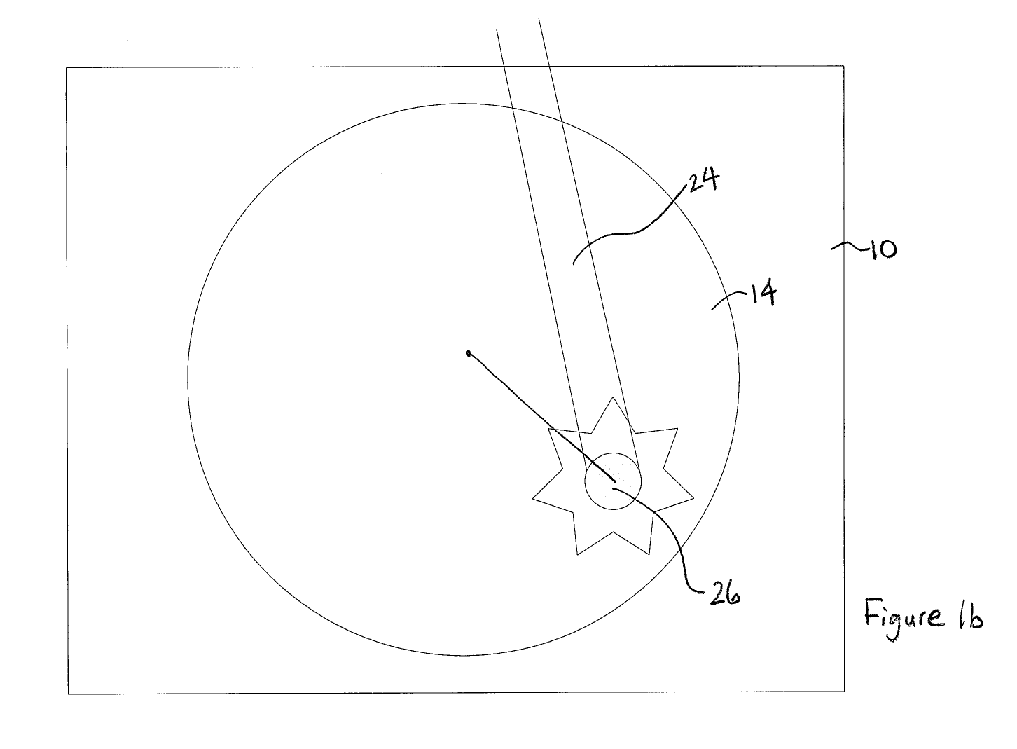

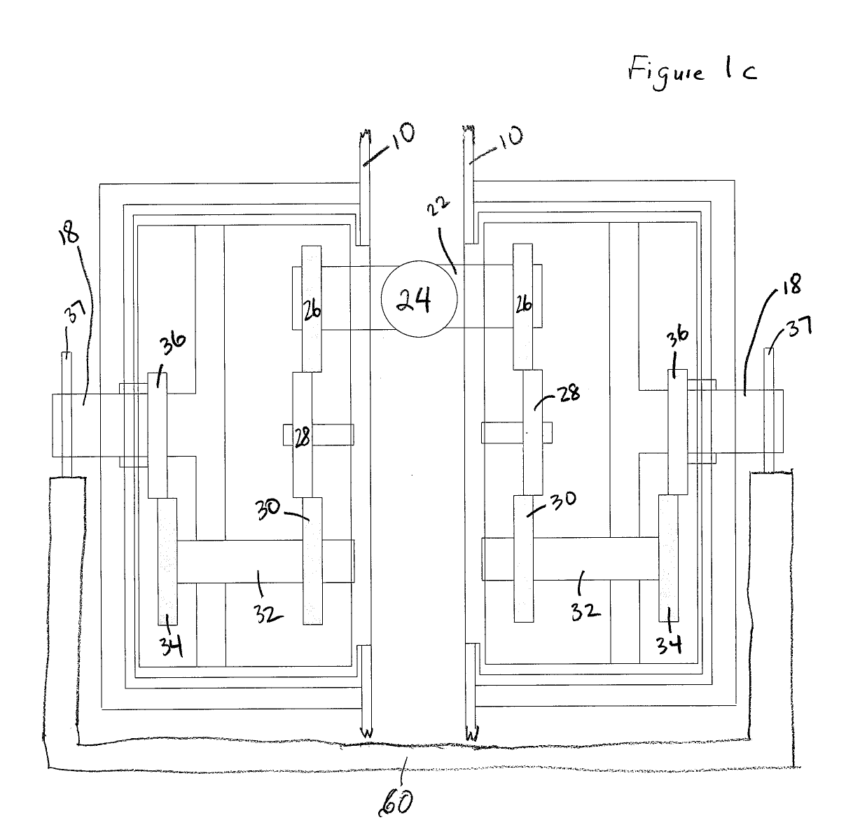

Turning to FIG. 1a, a schematic top view of an engine body is shown. The engine body 9 includes a rotating hub 14, a gear train 16 and a power shaft 18. Around the rotating hub 14 is a bracket 20 which can be used to fasten the engine body 9 to an engine block 10. The bracket 20 is used to mount the engine body into a vehicle frame. The bracket 20 is rotatable so that exact piston top dead centre (TDC) position with respect to the rotating hub 14 can be matched with the TDC of the crankshaft 22 to obtain maximum piston stroke. A gear 37, such as a timing gear, is located on the power shaft 18 to drive the valves and other parts of the engine during power shaft rotation. Connection of the gear 37 with these engine parts will be understood by one skilled in the art. Furthermore, as shown in FIG. 1c, a pair of hubs 14 can be mounted back to back, sharing the same crankshaft.

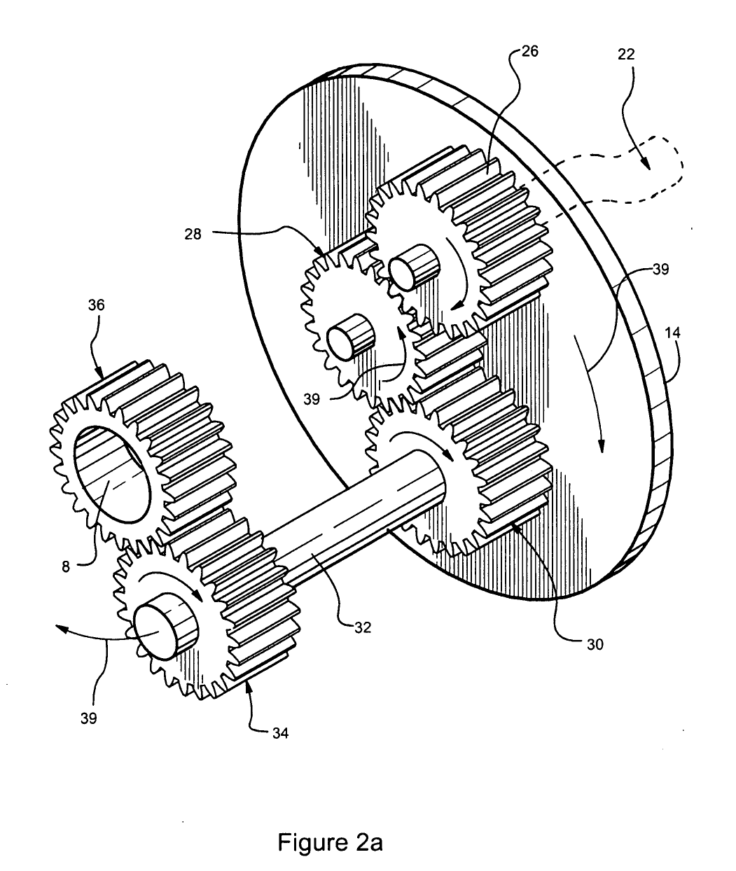

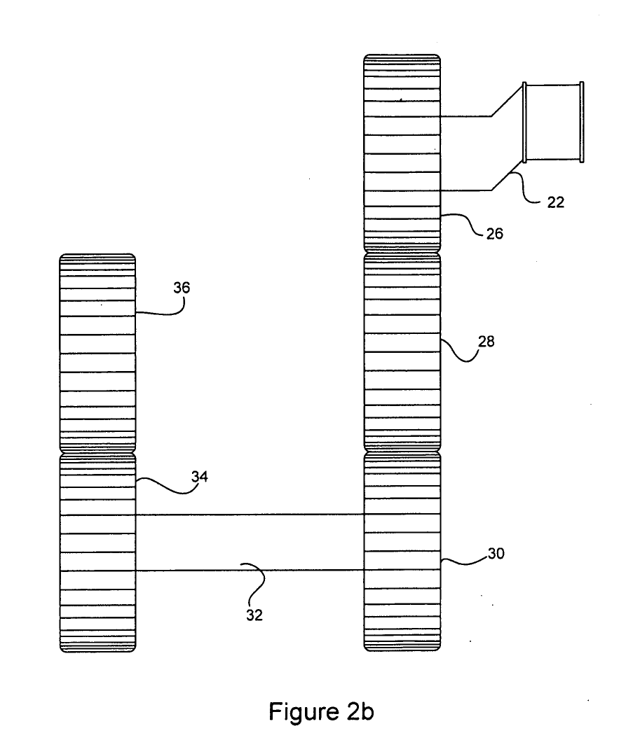

The hub 14 and/or engine block 10, is connected via a crankshaft 22 to a piston and connecting rod combination 24 which provides the initial motion to start up the rotating hub 14. Operation of the piston will be described in more detail below. Within the engine block 10, the other end of the crankshaft 22 is located within the rotating hub 14 and includes a crankshaft gear 26 which connects the crankshaft 22 to the gear train 16. The crankshaft 22 is mounted off centre inside the rotating hub 14 (as shown in FIG. 1b). The gear train 16, which will be described in more detail below with respect to FIG. 2a, comprises a set of gears, shafts and bearings to translate the motion of the piston directly to the power shaft 18 to operate the vehicle in an improved manner.

As shown in FIG. 1b, the connecting rod of the piston is connected in an offset manner from the centre of the hub due to the presence and design of the gear train 16. This offset connection allows for the engine to produce a greater amount of torque in one rotation of the hub 14 than known engines. Due to this design, the piston and connecting rod combination 24 reaches bottom dead centre twice during a single rotation of the hub 14. The hub 14 is kept in time and forced to rotate by the gear train 16 with an orbital, or orbiting, gear rotating around a stationary gear. The initial movement from TDC can be three times faster than current engines.

Turning to FIG. 2a, a schematic diagram of a gear train is shown. The gear train 16 includes an idler gear 28 which meshes with the crankshaft gear 26 and an intermediate gear 30. The intermediate gear 30 is connected via a shaft 32 to the orbiting, or orbital, gear 34 which meshes with the hollow stationary gear 36. As can be seen in FIG. 2a, the stationary gear 36 includes a hollow portion 8 which receives the power shaft 18. Therefore, when the piston and connecting rod combination 24 move, this motion causes the rotating hub 14 to rotate thereby imparting a rotational motion to the crankshaft 22 which causes the gears 28, 30, 34 within the gear train 16 to rotate in the direction of the arrows 39 around the stationary gear 36. As can be seen, the stationary gear 36 is mounted to the bracket 20 via a pair of brackets 39 in order to rotate the power shaft 18. The bracket 20 rotates somewhat to move the stationary gear 36 to maintain the continuity between the timing of the piston 24 and the hub 14 which drives the power output shaft 18. Alternatively, the stationary gear 36 can be rotated by bracket 39.

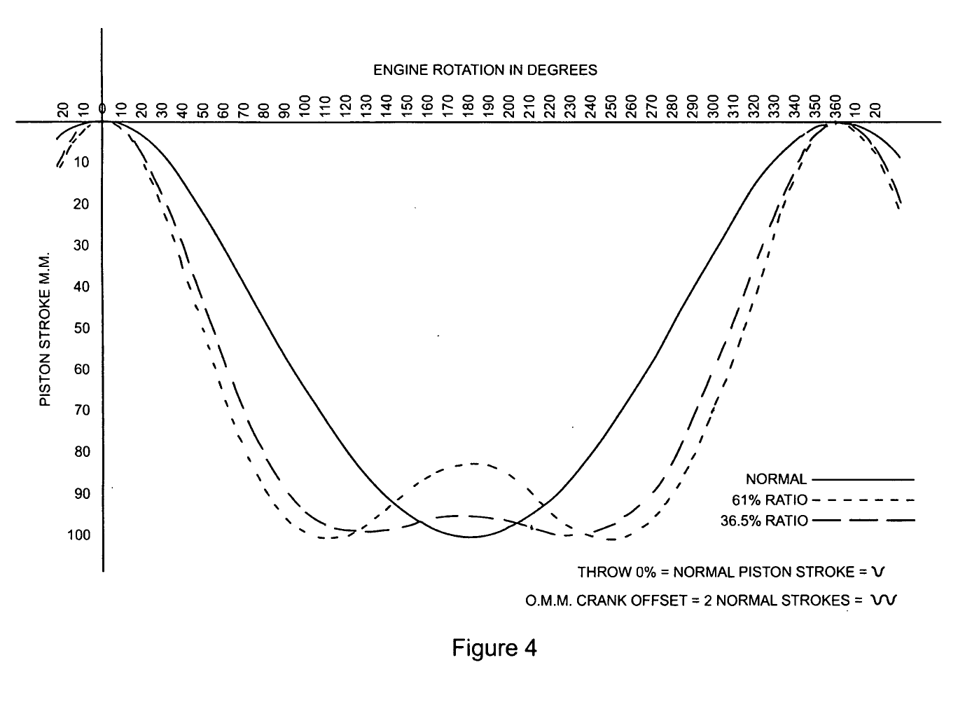

The presence of the idler gear 28 and the intermediate gear 30 allow for larger diameter gearing to be used in the stationary and orbital gears of the gear train 16 so that a higher level of horsepower can be transmitted compared with previous engine design. The movement of the piston 24 can be somewhat changed, with respect to current engines, in that the action of the piston with respect to the rotational movement of the hub and gears is not in direct relation. This is somewhat shown in FIG. 4 which is a graph showing different ratios of crankshaft throw to crankshaft offset on piston stroke via the current embodiment vs a normal piston stroke.

Assuming a 100 mm piston stroke, under normal conditions, as shown by the solid line, the piston simply starts at the top of the piston cylinder and goes to the bottom of the cylinder thereby rotating the hub 180 degrees and displacing the piston 100 mm from the original position. After reaching the bottom of the cylinder, or downward stroke, the piston moves in an upward direction until it reaches the top whereby the hub has completed a full rotation (360 degrees), or stroke, with zero displacement from the original position.

However, using the multi-gear embodiment disclosed above, assuming a 61% ratio, there is an improved engine efficiency and torque production. The ratio is the value of (the amount of crankshaft offset)/(crankshaft throw). A larger ratio therefore results in a more rapid piston movement with an upward movement of the piston at 180 degrees hub rotation. As with before the piston starts at the top of the cylinder. Due to the multiple gears in the gear train 16, when the piston reaches the bottom of the cylinder (or end of the power stroke), the hub has only rotated approximately 100 degrees. Therefore, to take advantage of this scenario, the piston is then urged upward towards the top of the cylinder until the hub has rotated 180 degrees. At this point, the piston is only displaced approximately 80 mm from the original, or starting location. The piston can then be urged downward to the bottom of the cylinder (reaching it at approximately 240 degrees rotation) before moving to the original position (thereby completing a full rotation of the hub). As the piston moves between 100 degrees and 240 degrees hub rotation, the exhaust fuels can be purged thereby allowing the engine to be used as a 2 cycle engine. Similarly with a 36.5% ratio, the piston reaches the bottom of the cylinder at approximately 120 degrees and approximately 220 degrees of hub rotation whereby exhaust can then be purged from the piston cylinder during these two piston positions.

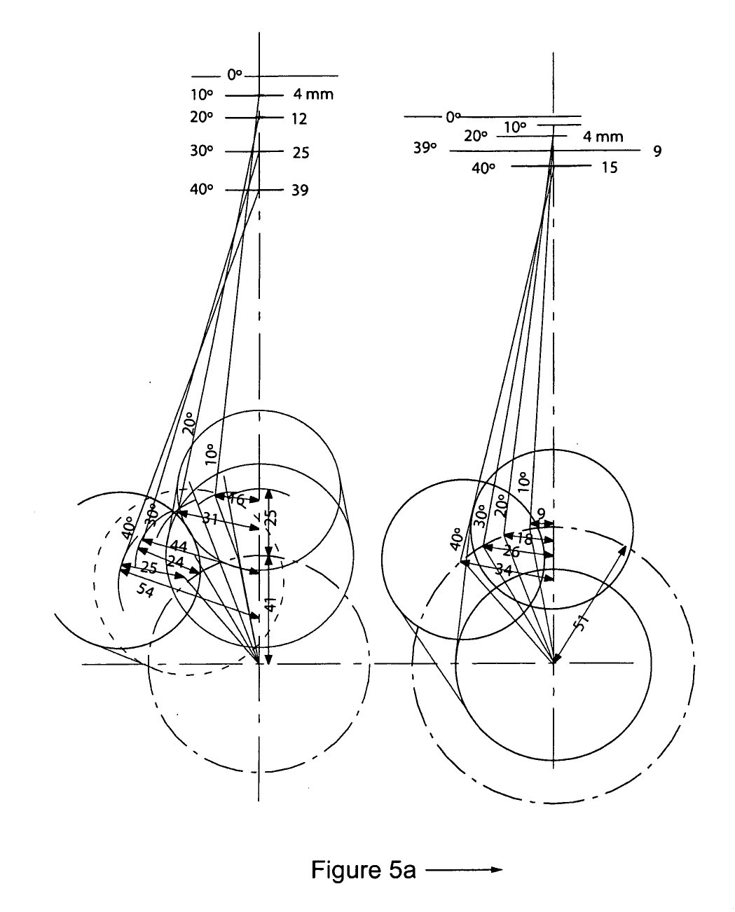

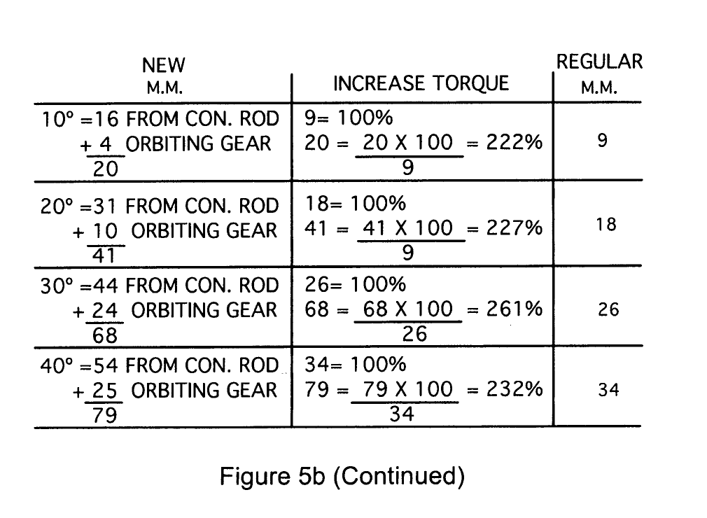

Both of these embodiments translate in an increased amount of torque being created by the engine which will be understood to be an advantage over current engines. This can be further seen in the calculations and accompanying drawings in FIG. 5.

FIG. 2b provides a schematic side view of a preferred embodiment of the gear train. In the preferred embodiment, the crankshaft gear 26 is an 18 tooth gear, the idler gear 28 is a 22 tooth gear, the intermediate gear 30 is a 19 tooth gear, the orbital gear 34 is a 19 tooth gear and the stationary gear 36 is an 18 tooth gear.

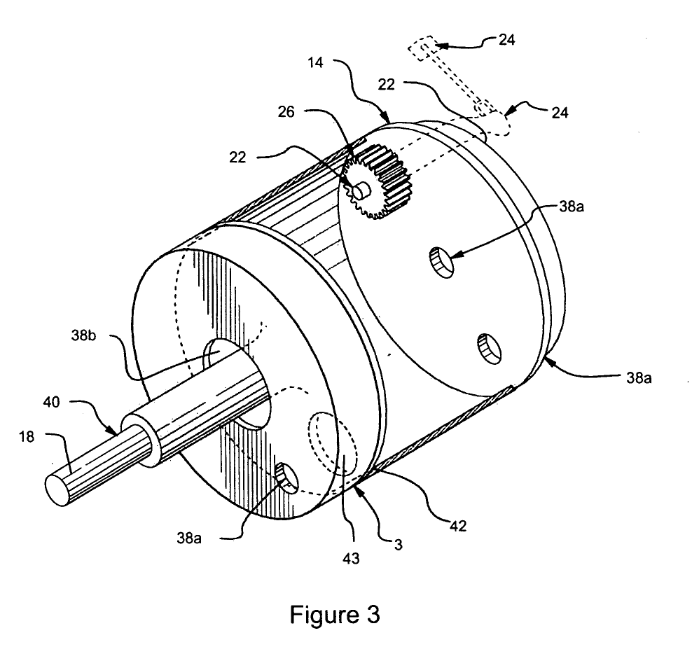

FIG. 3 provides a schematic view of the rotating hub and power shaft. As shown, one end of the crankshaft 22 is connected to the hub 14 in order to impart the necessary rotational motion to the gear train 16 when the piston 24 is in motion. The hub 14 further includes a set of apertures 38a for receiving bearings to hold the idler gear 28, the intermediate gear 30 and the orbital gear 34 in place. The rotating hub 14 further includes a larger aperture 38b for receiving a shaft portion 40 of the power shaft 18. The power shaft also includes a plate portion 42 which is located within the rotating hub 14 and includes an aperture 43 for receiving the shaft 32 connecting the intermediate gear 30 and the orbital gear 34.

In operation, movement of the piston and connecting rod combination 24 causes the rotating hub 14 and crankshaft 22 to rotate. Rotation of the crankshaft gear 26 drives the idler and intermediate gears 28 and 30 which imparts a rotation to the orbital gear 34 which then rotates around the stationary gear 36. The rotation of the orbital gear 34 causes the stationary gear to drive the power shaft 18 via the gear train and rotating hub. Due to the design of the current embodiment, the crankshaft 22 rotates once inside the rotating hub 14 per revolution of the rotating hub 14 which is an improvement over prior art engines. This drastically reduces or eliminates the need for the piston 24 to stop or slow down approximately halfway down the piston cylinder (at the bottom of the rotation in prior art engines). In the 61% ration embodiment, this improved movement from the top of its stroke, with the improved gearing, moves the piston quickly to the bottom of its stroke at approximately 110 degrees of the rotation of the rotational hub. From the bottom of the piston's stroke, it proceeds up towards the top of the piston cylinder approximately one-fifth of the way (depending on the engine design ratio), where it stops at 180 degrees of the rotating rub's rotation. The piston then goes down to the bottom of the stroke again before going directly to the top of its stroke, ending at 360 degrees of the rotation hub rotation. The piston will then begin its next power stroke.

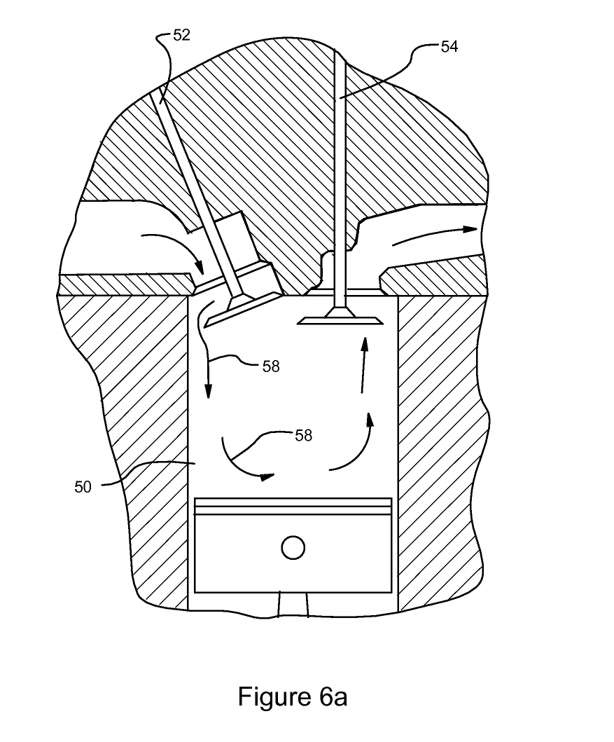

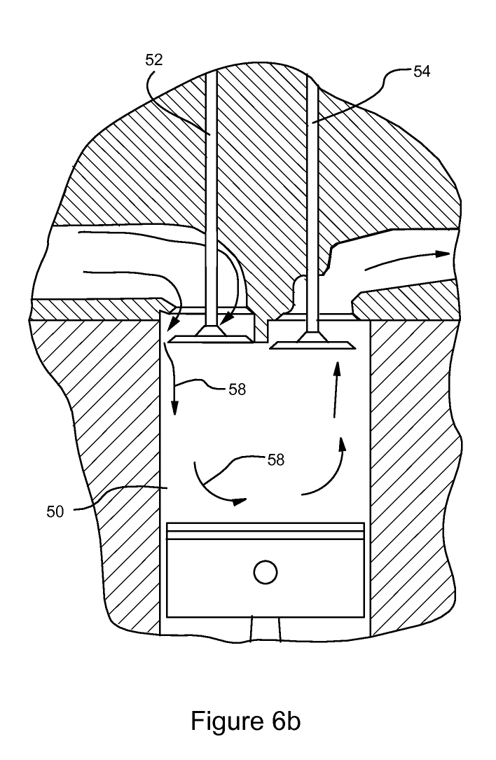

A schematic view of a operation of the piston with respect to the stroke is shown in FIG. 6. The piston and cylinder combination uses forced directed intake air for exhaust scavenging and combustion turbulence. At the top of the piston cylinder 50, there is an intake valve 52 and an exhaust valve 54 which allows fresh (forced) air to enter the cylinder and to allow exhaust to exit the cylinder, respectively. Assuming a 61% ratio, as the piston 24 is nearing the end of the power, or downward, stroke within the cylinder 50 (at 110 degrees), the intake valve 52 can be opened to allow fresh air to enter (be forced in) and the exhaust valve 54 opened to allow exhaust to be forced out. As the hot combustion gas is stored in the cylinder for a shorter period of time, the engine will absorb much less heat thereby providing a more efficient engine.

The angled and recessed positioning of the intake valve allows for the air to circulate in the manner shown by arrow 58 so that efficient air intake and exhaust purging is experienced. This also creates a turbulence for improved combustion of fuel. Use of this valve design would be advantageous in a four cycle engine as well.

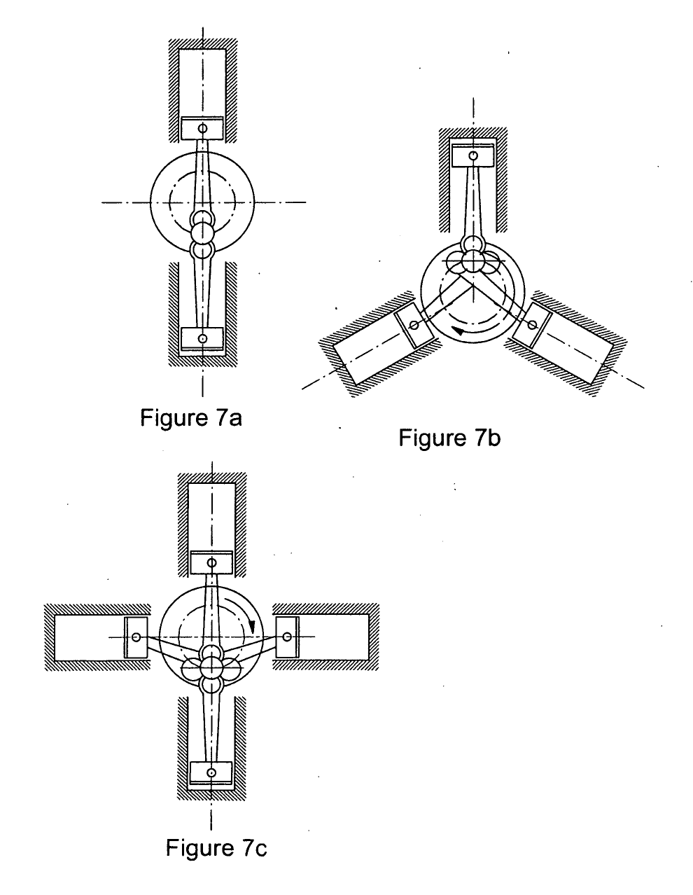

FIGS. 7a to 7c provide views of multiple cylinder embodiments whereby each cylinder uses the same crankshaft and fires in a coordinated manner. As can be seen, the engine can have one to four pistons.

Turning to FIG. 1c, a further embodiment of an engine is shown. In this embodiment, there are two rotating hubs which are mirror images of each other and connected to a common crankshaft 22. Operation of the individual hubs, is as discussed above. Although not shown, up to four pistons can be connected to the crankshaft 22.

In this dual rotating hub embodiment, the timing gear 37 on each power shaft 18 is connected to each other by a shaft 60 and can be used to keep the rotating hubs 14 in time on each end of the crankshaft 22 and to transmit power from the power shaft of one rotating hub to the power shaft of the other rotating hub, if necessary in a multi-cylinder design. The rotation of the individual power shafts 18 also powers the various parts of the engine, as will be understood by one skilled in the art. Also by having multiple hubs, there is less strain on the gearing thereby reducing the wear and extend the life of the parts of the engine. The shaft 60 that connects the two timing gears transmits power for the normal engine components such as the generator, hydraulics, valve operation, injection pump, starter, etc.

One advantage of the current invention is that the presence of the idler gear and the intermediate gear allows the crankshaft gear to not have to mesh directly with the stationary gear thereby allowing larger gears to be used. This is helpful in assisting in the placement of bearings to hold the gears in place. Using different sized gears also reduces the wear on these gears. This is the benefit of the gear train. Also, larger gears are needed for larger horse power engines.

Another advantage is the use of the hollow stationary gear 36 so that power can be delivered through to the power shaft from the rotational hub 14 without having to go through any extra gearing.

With the present design, the size of the engine can also be reduced as the current engine can provide an equivalent torque and power of a four cylinder engine of a four cycle design assuming the new diesel has 200% more torque.

One advantage of the improved engine is that the piston's delay in returning to the top of its stroke, after it's fast movement to the bottom provides the opportunity for the burnt fuel, or exhaust to be purged. The pressurized air could flow into the cylinder through the intake valve and force exhaust out the normal exhaust valve.

Another advantage is that as the piston returns to the top of its stroke faster than some current piston engine designs, the stress on engine parts is reduced in the 2 cycle design as the piston compresses the fuel-air mixture on each upward stroke and it ignites it just before the piston reaches the top of its stroke. The increased pressure cushions the stop of the piston and sends the piston quickly on its downward (power) stroke.

Due to the current design, the stroke translates to an improved torque. The torque increases as the crankshaft is offset in the hub and axis of the throw of the crankshaft.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. An engine comprising:
a piston and piston rod combination;
a rotational hub;
a crankshaft, connected at one end to the piston and piston rod combination and at a second end to the rotational hub;
a gear train including an orbital gear, a stationary gear and a plurality of intermediary gears; and
a crankshaft gear, located on an end of the crankshaft, the crankshaft gear meshing with the gear train so that movement of the crankshaft can drive a drive shaft.

2. The engine of claim 1 wherein the intermediary gears are meshed together with one of the intermediary gears meshed with the crankshaft gear and another of the intermediary gears connected via a shaft to the orbital gear and the orbital gear and the stationary gear meshed together.

3. The engine of claim 2 wherein the stationary gear includes a hollow portion through which the drive shaft is located.

4. The engine of claim 3 whereby the rotation of the gears in the gear train cause the drive shaft to rotate.

5. The engine of claim 1 wherein the movement of the piston

6. The engine of claim 1 wherein the orbital gear and the stationary gear are substantially the same size.

7. The engine of claim 1 wherein the piston and piston rod combination are located within a piston cylinder.

8. Then engine of claim 7 wherein the piston cylinder includes an intake valve and an exhaust valve.

9. The engine of claim 8 wherein the intake valve is angled and recessed with respect to a body of the cylinder.

10. The engine of claim 1 wherein the crankshaft is connected in a manner such that it is offset from the axis of the rotational hub.

11. The engine of claim 1 further comprising at least two piston and piston rod combinations connected to one crankshaft.

12. The engine of claim 1 wherein the pistons fast downward movement from a top down centre position produces more torque to the crankshaft early in its strokes, before the combustion gas cools in the engine cylinder.

13. The engine of claim 1 further comprising:
a second rotational hub;
a second gear train including an orbital gear, a stationary gear and a plurality of intermediary gears; and
a second crankshaft gear, located on an end of the crankshaft, the second crankshaft gear meshing with the gear train so that movement of the crankshaft can drive a drive shaft.

14. The engine of claim 13 further comprising a timing gear to synchronize the motion of the first and second rotating hubs.
